(19) United States
(12) Patent Application Publication
(10) Pub. No.: US 2008/0101400 A1
(43) Pub. Date: May 1, 2008

(54) MANAGING ATTACHMENT OF A WIRELESS TERMINAL TO LOCAL AREA NETWORKS

(75) Inventor: Otso Auterinen, Helsinki (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/554,166

(22) Filed: Oct. 30, 2006

(51) Int. Cl. H04L 12/66

(52) U.S. Cl. 370/463; 340/572.1

(57) ABSTRACT

The invention relates to managing and controlling access by a user wireless device (MD) to a wireless local area network (WLAN) at an access point or “hotspot”, while protecting the security of the WLAN. The hotspot and associated advertisement describe an available communication service at the hotspot. A RFID device is embedded in the advertisement providing instructions for attachment of the user's mobile device (MD) to the communication service, e.g. a WLAN. After evaluation of the instructions and establishing a security relation between the MD and a mobile management entity (MME) included in a wide area network (WAN), the MME provides attachment information for the MD to the WLAN. The attachment is completed after verification by the WLAN of the MME approval of the MD attachment, and establishing a session key for messages between the MD and the WLAN.

### BACKGROUND OF THE INVENTION

1. Field of Invention

This invention relates to mobile communication methods, apparatus, computer program products and systems. More particularly, the invention relates to managing and controlling access to a wireless local area network (WLAN) at an access point or “hotspot”, while protecting the security of the WLAN.

2. Description of the Prior Art

“Hotspot” based wireless services relate to adhoc networks using short-range wireless systems, typically Bluetooth, and provide proximity based wireless services to mobile terminals at “hotspots” or public spaces where people crowd together—airport terminals, shopping malls, sporting events and the like. The hotspot services can be related to any type of service associated with the hotspot, e.g. local area network or internet connection; airline reservations, shopping, real time ticket purchase for sporting events and amusement park admission, billing services for wireless communication within the coverage area. A hotspot can be tailored to and dedicated for one service only, or alternatively provide a range of related services, e.g. airline, train and bus schedules at different terminals; hotel, motels, residences and the like. The services are provided in a coverage area via a hotspot access point or hotspot server, which may use any suitable short-range communication technology, such as, for example Bluetooth technology or IEEE 802.11x WLAN technology as front end technology and at the back end provides a high speed wired or wireless connection to a local area network or the Internet.

A problem for users at a hotspot includes identifying available services, and easily connecting to a service using short range communication processes, e.g. Bluetooth, IEEE 802.11, etc. In the case of a user desiring to connect to a local area network at the hotspot, additional problems are created due to preserving the security of the network. A user must be cleared for access to the network using authorization and authentication protocols, which can be complex for the ordinary user and time consuming. What is needed in the art is a mechanism at the hotspot for advertising services, particularly network services, available at the hotspot and enabling the user to efficiently connect to the network without compromising the security of the network.

The present invention overcomes the problems of a user obtaining communication services at the hotspot by advertising the availability of communication services at the hotspot, via a physical object, e.g. a poster or sign poster or the like; including in the advertisement machine-readable information, such as, for example, a RFID device providing instruction for the attachment; reading the RFID device with a mobile terminal; evaluating the RFID information to determine whether to access the local area network, and using the RFID information to contact a terminal on a wide area network for approval to contact the local area network, based upon a previous security arrangement between a wide area network element and the mobile terminal, and attachment to the local area network after verification of the wide area network element approval of the user by the local area network.

Related material of interest with respect to attachment to a WLAN initiated from a hotspot includes:

1) USPA 20050097356, published May 5, 2006, filed Oct. 29, 2003, discloses a hotspot access point enables a mobile wireless device to resume a service with a network server when service is interrupted by the mobile device moving out of the coverage area of the access point. A short-range communication link is established by the access point with the mobile device based on a local identification of the device. The access point requests additional information from the wireless device. The additional information relates to a wide area network identification of the device. The mobile device transmits additional information to the access point, which stores the local area identification and additional identification. The access point transmits to the mobile device a coded identificator of the wireless device based upon the local area identification and a network identification of the device. The access point determines whether service with the mobile device is open and establishes a wide area connection with the mobile device.

2) USPA 20040002303, published Jan. 1, 2004, discloses facilitating the initiation/execution of mobile services using radio frequency transponders. Transponders or “tags” having information associated therewith are provided at a location accessible to a mobile device user. A visual representation is associated with each of the transponders, where each visual representation corresponds to a communication function to be performed. A transponder is activated, via a wireless signal transmitted by the mobile device, in response to the mobile device being positioned proximate the visual representation associated with the transponder. The information from the activated transponder is received at the mobile device, which in turn invokes a mobile device application identified at least in part by the information received by the mobile device. The function corresponding to the visual representation is performed in response to invoking the mobile device application.

3) U.S. Pat. No. 6,795,700 issued Sep. 24, 2004, discloses creating incentives for wireless hotspots by a service provider is disclosed. An access point is provided to a wireless hotspot for wireless devices to wirelessly connect to a larger network in a publicly accessible location. Use of the access point for a portable device is authenticated by requesting submission of an account identifier to the service provider and billing data for a user of the portable device for use of the access point is generated. Use statistics are evaluated of the access point of the wireless hotspot by portables devices and an inducement is provided to the publicly accessible location based on the evaluated use statistics.

None of the cited art discloses or suggests (1) a hotspot providing a wireless short-range communication network and associated advertisement describing available communication service at the hotspot; (2) a machine-readable indication in a form of e.g. a RFID device embedded in the advertisement providing instructions for attachment of the user's mobile device (MD) to the communication service, e.g. a WLAN; (3) implementing the instructions, after evaluation by the user; connecting to a wide area network station, serving as a proxy for the WLAN in approving the attachment of the MD to the WLAN, after establishing a security relation between the MD and a mobile management entity (MME) included in the network station; and (4) attachment of the MD to the WLAN, after verification by the WLAN of the MME approval of the MD attachment, and (5) establishing session keys for messaging between the MD and the WLAN.

### SUMMARY OF THE INVENTION

The invention describes managing and controlling a user mobile device (MD) access to communication services, e.g. a wireless local area network (WLAN) at a hotspot. The availability of the WLAN is advertised at the hotspot by a physical display, e.g. a sign or poster. A radio frequency identification (RFID) tag is embedded in the sign or poster for scanning or communication with a RFID reader. The tag includes stored electronic information regarding the WLAN, including instructions for accessing the WLAN. The MD includes a RFID reader to scan the tag to receive and store in the MD a message containing the tag electronic information. The tag information includes the address of the WLAN; the address of a server including a mobile management entity (MME) in a wide area network (WAN), and a user requirement for a security association with the MME, e.g. a subscription identifying the user for MME service for access to the WLAN. The MD includes logic for evaluating the tag information and determining the user's interest in accessing the WLAN. Assuming user interest, the MD sends a signed message to the MME according to the security association under the MME subscription. The message includes the WLAN address for attachment and the identity of the user. The MME records the user message for expediting subsequent user requests for WLAN attachment. The MME transmits an approval message to the MD containing WLAN connection information enabling attachment of the MD to the WLAN. The message includes WLAN channel information; a WLAN service set Identifier (SSID) or a password, and similar information to discover the WLAN. Based on the MME approval message, the user sends an attachment message to the WLAN, which authorizes attachment to the WLAN, after verifying the MME approval message and the establishment of a security or trust relation with the MD using session keys

An aspect of the invention is a MME in a WAN serving as a proxy for a WLAN in approving the attachment of a MD to the WLAN.

Another aspect is a process generating secret keys for establishing session keys for communication between the MD and the WLAN.

Another aspect is a RFID tag embedded in a physical object, e.g. a poster or sign, the tag providing instructions for attachment of a mobile device to a WLAN network.

Another aspect is storing video, text and image in RFID for instruction in attaching a MD to a WLAN.

Another aspect is an extensible authentication protocol supported by the WLAN for authorizing the attachment of a MD to a WLAN to identify the MD and the WLAN.

Another aspect is recording quality metrics by the MD for the WLAN sessions.

### DESCRIPTION OF DRAWINGS

The invention will be more fully apprehended from the following detailed description of a preferred embodiment, taken in conjunction with an appended drawing, in which:

FIG. 1 is a representation of a wireless system for managing and controlling access by a user mobile device (MD) at a hotspot to a wireless local area network (WLAN), after approval of the attachment by a mobile management entity (MME) in a wide area network serving as a proxy for the WLAN without compromising the security of the WLAN, according to embodiments of the present invention:

FIG. 1A is a representation of a hotspot in FIG. 1 according to one embodiment of the present invention;

FIG. 1B is a representation of a RFID device at a hotspot in FIG. 1 providing electronic description and attachment information of a WLAN for initiating attachment of a MD to the WLAN, according to one embodiment of the present invention;

FIG. 2 is a representation of a MD in FIG. 1, according to one embodiment of the present invention;

FIG. 2A is a representation of a Base Station including a mobile management entity (MME) in a wireless area network (WAN) in FIG. 1, according to one embodiment of the present invention;

FIG. 3 is a flow diagram of a RFID assisted attachment of a MD to a WLAN using a MME station as a proxy for approving the attachment of the MD to the WLAN in the system of FIG. 1, according to one embodiment of the present invention;

FIG. 3A is a representation of a RFID message to the MD in the process of FIG. 3, according to one embodiment of the present invention;

FIG. 3B is a representation of a request message from the MD to the MME in the process of FIG. 3, according to one embodiment of the present invention:

FIG. 3C is a representation of an approved message from the MME to the MD in the process of FIG. 3, according to one embodiment of the present invention;

FIG. 3D is a representation of an attachment message from the MD to the WLAN in the process of FIG. 3, according to one embodiment of the present invention; and

FIG. 4 is a flow diagram implementing a security relationship between the MD and the WLAN by establishing session keys for messaging between the MD and the WLAN in the process of FIG. 3, according to one embodiment of the present invention.

### DESCRIPTION OF PREFERRED EMBODIMENT

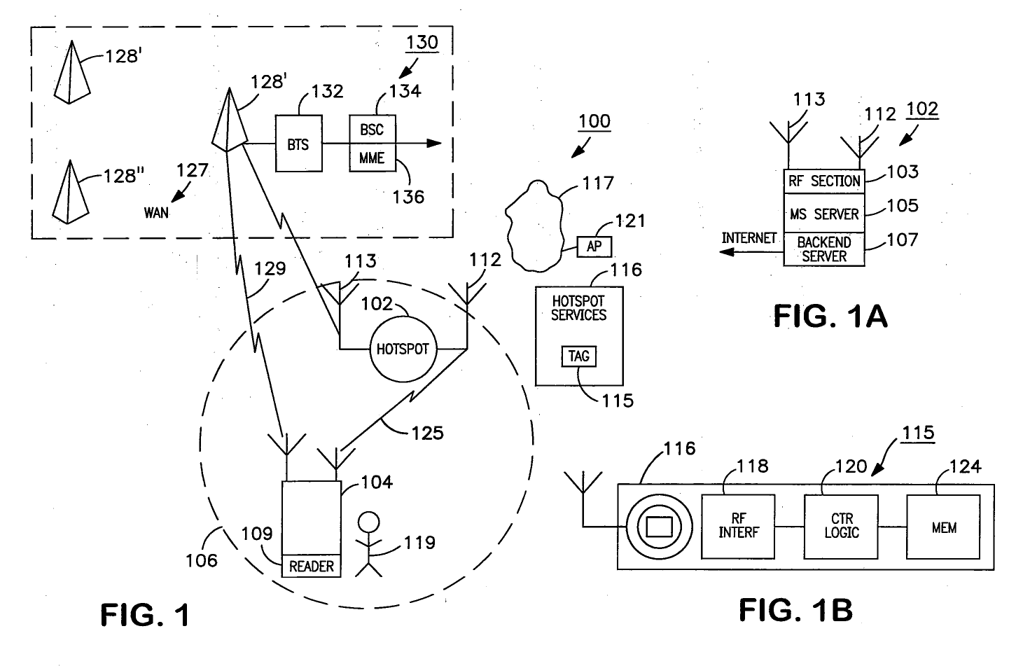

Referring to FIG. 1, a system 100 is disclosed for managing and controlling access to a wireless local area network (WLAN) by a user wireless device (MD) according to embodiments of the present invention. The user device comprises almost any portable or stationary device, which includes a wireless communication interface for contact less communication with a data carrier. Such user devices comprise, without limitation, for example, stationary or cordless or mobile telephones, wireless handheld e-mail devices, scanning devices, smart cards, and stationary or portable computer systems including, for example, personal computers, workstations, personal data assistant, notebook computers, and the like

The system provides the user with a simple way of accessing the local area network without compromising the security of the WLAN. It should be noted that for the purposes of the present invention, WLAN is used for the purposes of the present patent application to cover all possible wireless local area network technologies, including, but not limited to Bluetooth technology, various wireless fidelity (WiFi) IEEE 802.11x technologies and UWB technology, to name a few non-limiting examples. A hotspot 102 provides a mobile device 104 with wireless connectivity to access service providers, when the terminal 104 is within a wireless coverage area 106, served by the hotspot. Hotspot access points are commercially available from several manufactures, including CISCO Corp., Santa Clara, Calif. As shown in FIG. 1A, the hotspot access point 102 includes an RF section 103, a server 105 configured to communicate according to one or more short-range wireless communication systems, such as, for example 802.11 or WLAN at the front end and a back end server 107 providing a high-speed wire to wireless connection to the Internet. The server executes a standard operating system implementing communication protocols, via an antenna 112, for the short-range wireless communication systems and may further include an antenna 113, for connecting to cellular long range networks, such as, for example GSM or UMTS networks. The server includes a dedicated application (not shown) in the server for establishing a session with the mobile device 104 and recognized in the MAC address of the mobile device. The access point is coupled to the Internet, via a wireless link or a wired connection.

Associated with the hotspot and positioned adjacent thereto, is a physical object or display 116, e.g., a sign or a poster or the like, advertising the availability of communication services to a user 119 from a wireless local area network (WLAN) 117. The sign or a poster 116 includes a RFID tag 115, or other suitable means for storing machine readable data, embedded in the sign or the poster providing information including establishment of an RF link 125 to the MD 104 for initiating attachment of the mobile device 104 to the WLAN 117, when scanned by a RFID reader or other suitable means for reading the data. The RFID tag can be either active or passive. Active tags require an internal battery and are often read/write tags. Passive tags do not require a dedicated power source, but rather, obtain operating power generated from the reader signal. The construction and operation of an exemplary RFID tag will be described in conjunction with FIG. 1B.

Returning to FIG. 1, the MD 104 includes a RFID reader 109 or other suitable means interfacing with the RFID or other tags holding data for initiating attachment of the MD 104 to the WLAN 117. An RF signal 125 is transmitted from the RFID reader that activates the tag when placed within a predetermined range of the tag. When a tag has been activated, it transmits stored information back to the RFID reader 109. When the RF field passes through the antenna coil associated with the tag, a voltage is generated across the coil. This voltage is only used to power the tag and make possible the tags return transmission of information to the reader, sometimes referred to as back-scattering.

FIG. 1B shows further details of the tag 115. The RFID tag 115, in one embodiment includes an RF interface 118, control logic 120 and a memory 124. The RF interface 118, is coupled to an antenna 116 including a coil and an RF receiver (not shown) to recover analog signals transmitted by the reader 109. The control logic 120 controls the function of the RFID tag, in response to commands provided by the RFID reader that are embedded in the recovered RF signal from the reader. The control logic 120 accesses the memory 124 to read and or write data there from. The control logic also converts analog data signals recovered by the RF interface 118, into digital signals comprising the received commands and converts digital data retrieved from the memory into analog signals that are back-scattered modulated by the RF interface 118. The RFID tag may be adapted to derive electrical power from the antenna generated signal provided by the RFID reader, or, may include an internal power source. The memory 122 contains space for data storage having plural fields that may be defined by an end user. The memory may be preloaded with the address field identifying the WLAN network 117 for attachment to by the MD 104.

Returning to FIG. 1, the MD 104 also communicates with a cellular wide-area network (WAN) 127 including base stations 128¹, 128² and 128^{N.} via radio link 129. The base station 128 includes a base station transceiver 132 and a base station controller 134, including a mobile management entity 136, which may serve as a proxy for the WLAN 117 in authorizing attachment of the mobile device 104 to the WLAN 117, as will be described in more detail hereinafter.

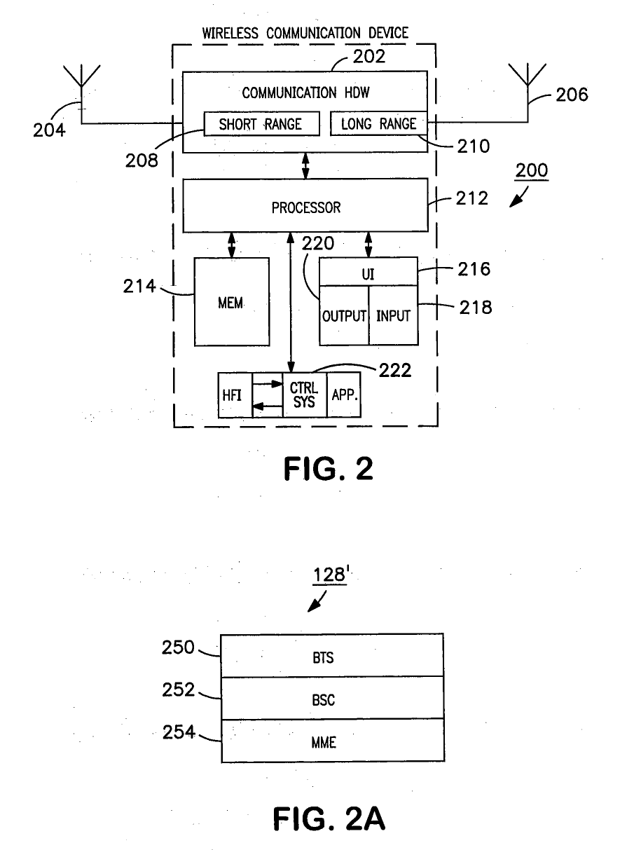

FIG. 2 shows a wireless communication device 200 corresponding to the mobile device 104 in FIG. 1, according to one embodiment of the present invention. The device 200 includes a communications hardware unit 202 which includes electronics, such as a transceiver and a diplexer. These electronics allow the device 200 to engage in bidirectional RF communication via antennas 204 and 206 using short range 208 and long range 210 communication modules with various short range and long range network entities, such as a cellular base station and Bluetooth access points. The communication modules 208 and 210 may include distinct components. In addition, the communication modules 208 and 210 may share certain components. The communication modules 208 and 210 may each transmit and receive signals via separate antenna, or may alternately share one or more antennas. A processor 212 is coupled to the hardware unit 202. The processor 212 controls all the functions of the device 200. For example, the processor 212 constructs and controls the operation of the communication hardware unit 202. The processor 212 may be implemented with one or more micro processors that are each capable of executing software instructions stored in a memory 214.

A user interface 216 is coupled to the processor 212. The user interface 216 includes a user input unit 218 and a user output unit 220. The user input unit may include one or more devices that allow a user to input information. Examples of such devices include keypads, touch screens and microphones, all not shown. The user output unit allows a user to receive information from the device 200. The user output unit 220 may include various devices such as a display and one or more audio speakers. Exemplary displays may include liquid crystal displays and video displays.

The memory 214 stores information in the form of data and software components. These software components include instructions that can be executed by the processor 212. Various types of software components can be stored in the memory 214. For instances, the memory 214 may store software components that control the operation of hardware unit 202 and software components that controls the exchange of information through the user interface 216. In addition, the memory stores software components that is associated with user applications that allow the device 200 to engage in communication sessions with other devices. These communications sessions include telephony and remote server access with devices across long range networks as well as service sessions with short range devices across ad hoc networks.

A RFID reader 222 (corresponding to reader 109 in FIG. 1) may be attached to the processor and comprises a high frequency interface including an antenna (not shown) for receiving a tag signal. The HF interface comprises two signal paths, a transmitter path and a receiver path. The interface is coupled to a control system generating a tag inquiry signal via the transmitter path and processing tag data received from the tag, via the receive path according to an application stored in the reader. Further details of a reader are described in the text “RFID Handbook” by K. Finkenzeller, published by John Wiley & Sons, Ltd., 1999, pages 200-202.

FIG. 2A provides additional details on the base station 128 included in the cellular Wide Area Network (WAN) 127, shown in FIG. 1B according to one embodiment of the present invention. Cellular WANs are described in the text “Wireless LANs” by Jerry Geier, published by McMillian Technical Publishing, 1999, pages 71-82 (ISBN 1-57870-081-7). WANs include multiple base stations for switching connections among base stations as a mobile device moves from one base station to another. Each base station includes a base station transceiver 250 coupled to a tower antenna. The base station transceiver provides cellular communications which consist of radio transmission and reception equipment covering a geographic area. The base station transceiver is controlled by a base station controller 252. The base station controller supervises the functioning and control of multiple base transceiver stations and acts as a small switch. A Mobile Management Entity (MME) 254 provides management and control of security associations between the base station and user mobile devices subscribing to the WAN. The user in subscribing to the WAN provides background information identifying the user and enabling the user to be accepted by the MME for WAN transmissions. The MME may also serve as a proxy for the WLAN 117 (FIG. 1) in authorizing attachment of the user mobile devices to the WLAN, according to one embodiment of the present invention. The MME is aware of network access nodes/base stations, and has access to network topology information, e.g. identity of base stations and security credentials of the base stations. The MME also generates and/or distributes encryption/decryption keys to base stations. The MME is described in “Technical Specifications 23882”, published by the 3^{rd} Generation Partnership Project (3GPP), available from the European Telecommunications Standards Institute (ETSI), Mobile Competence Center 650, Route Des Lucioles, 06921 Sophia-Antipoles Cedex, France. The Technical Specifications 23882 is fully incorporated herein by reference.

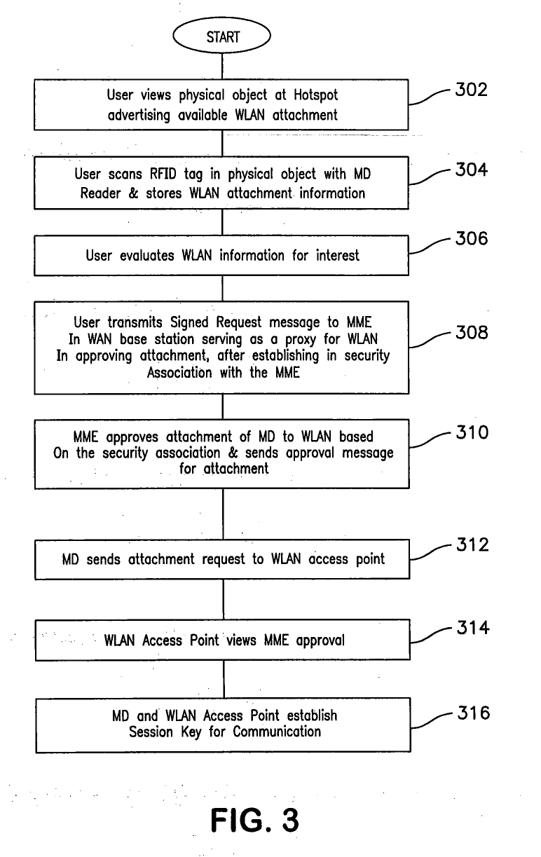

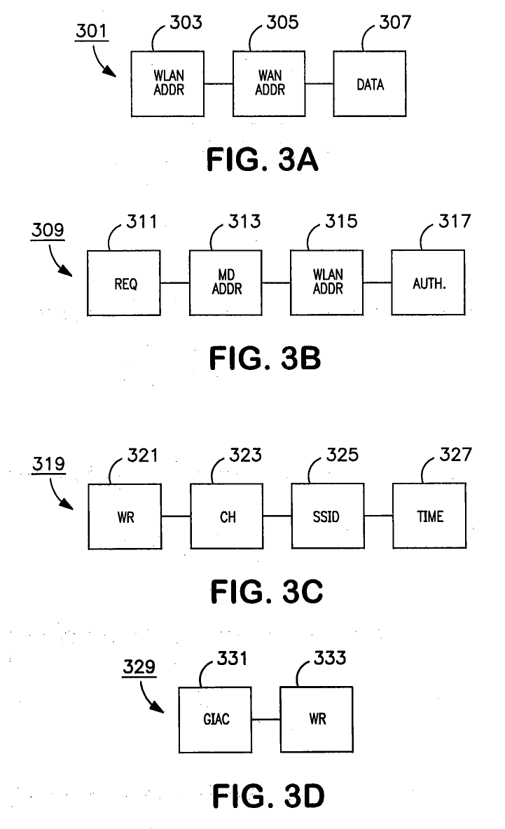

FIG. 3 in conjunction with FIG. 1 describes a process 300 for RFID assisted attachment of the mobile device 104 to the WLAN 117 via access point 121, according to one embodiment of the present invention. The process begins in an operation 302 when the mobile device 104 enters the coverage area 106 of the hot spot 102 and a user 119 of the mobile terminal views the physical object 116, typically a sign or poster advertising the availability of a wireless local area network providing various communication services. The physical object includes a RFID tag 115 or other similar means to provide machine readable data including stored information describing at least one WLAN; providing information needed for connecting to the WLAN and data describing the available WLAN communication services. The WLAN data may include voice, text and image.

In an operation 304, the user scans the tag with the reader 109 in the mobile device 104, if interested in receiving the WLAN information. The information may be provided to the reader in an electronic message 302 shown in FIG. 3A. The message may include a WLAN address 303, a WAN address 305, and data 307 describing the WLAN and its services, which may be in voice, text, and image.

In an operation 306, the user evaluates the tag information for interest using configured logic stored in the MD 104. Alternatively, the user may self evaluate the voice, text and image information to determine interest in accessing the services available in the WLAN.

In an operation 308, assuming interest, the user transmits a signed request message 309 via a link 129 to a mobile management entity (MME) 136 in the WAN 127 seeking attachment to the WLAN. The message 309, shown in FIG. 3B may include a request field 311, a MD address 313, a WLAN address 315, and an authorization 317 based on the security association with the MME 136. The message 309 allows the MME 136 to identify the user and the WLAN, and confirm the security association. By agreement with the WLAN, the MME 136 serves as a proxy for the WLAN in authorizing attachment of the MD 104 to the WLAN based upon a previous user-MME security association. Alternatively, the user may use the extensible authorization protocol (EAP), a general protocol for authentication that supports multiple authentication methods, such as tokens cards, passwords, public key authentication and smart cards. IEEE 802.1X specifies how EAP should be encapsulated in data frames. To use EAP, a user requests a connection to a WLAN through an access point (AP) which then requests the identity of the user and transmits that identity to an authentication source such as RADIUS. The server asks the AP for proof of identity, which the AP gets from the user and then sends it back to the server to complete the authentication. EAP is defined in Requests For Comments (RFC3748) “Extensible Authentication Protocol (EAP)” by the Internet Society (June 2004), and is fully incorporated herein by reference.

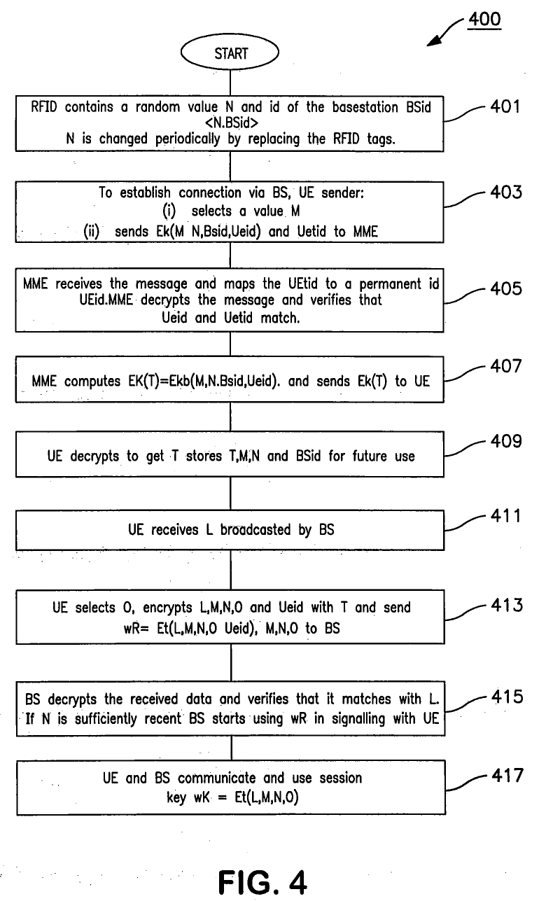

In an operation 310, the MME 136 approves attachment of the MD 104 to the WLAN 117 based on verifying the security association with the MD and sends an approval message 319 to the MD 104 via the link 129. The approval message 319 shown in FIG. 3C may include a session key as an authorization field 321, a channel identifier 321, a service. One or more session keys may be a randomly generated encryption/decryption key, generated according to FIG. 4 (to be described hereinafter). The one or more encryption/decryption keys preserve the security of the wireless local area network in a communication session with the MD. However, it should be noted that in broadest sense the session key can be any kind of security token that can be used for verifying that a previous security association between the MD and MME exists. The session key may be regularly changed for each communication session between the MD and the WLAN, which preserves the security of the WLAN. Prior to sending the message 319, the MME records the user request as a record for expediting subsequent user requests.

In an operation 312, the mobile device 104 sends an attachment request 329 shown in FIG. 3D to the WLAN access point 121. The attachment message 329, shown in FIG. 3D, includes a short range or Bluetooth general inquiry access packet 321 including the session key wR from the MME approval message 319.

In an operation 314, the WLAN access point 121 verifies that the user 119 and the MME 136 have performed a handshake authorizing the MD 104 to access the WLAN 117. The verification may also be done locally based on a security association between the WLAN 117 and the MME 136 or by message exchange between the WLAN 117 and the MME 136.

In an operation 316, the MD 104 and the WLAN access point 121 use the session key for communication based upon a security process shown in FIG. 4. After establishment of the session keys, the attachment is completed and messaging between the WLAN 117 and MD 104 continues using a session key wK.

FIG. 4 in conjunction with FIG. 1 discloses a process 400 for establishing the connection between the User Equipment (UE) or MD 104 and the WLAN 117 using session keys according to one embodiment of the present invention. The session keys enable encryption/decryption of messages between the UE or MD 104 and the WLAN 117, and preserve the security of the WLAN. The definitions for the process 400 include the following:

a. BS=WLAN access point.

b. UE=user equipment.

c. MME=Mobile Management Entity.

d. SIM=Subscriber Identity Module

The parameters in the process 400, include the following:

(i) K is a secret key known by a UE and MME. K is typically created in an initial access procedures based on a UE subscription to a WAN and e.g. a SIM in the UE.

(ii) K_{B} is a secret key known by an access point BS and MME.

(iii) UEtid a temporary identifier of UEid known by MME.

(iv) K and K_{B} represent a security association.

(v) Ek ( ) and Ekb ( ) represent encryption with K and K_{B} respectively.

(vi) L is a parameter selected by the BS provided to the UE via a short-range communication link.

(vii) M is a random number selected by the UE that is used to create association between UE and MME.

(viii) O is a random number selected by the UE that is used to create association between UE and BS based on previous association between UE and MME.

The process starts in an operation 401 wherein the RFD tag 115 contains a random value N and id of the WLAN base station 121 <N, BSid>. N may be changed periodically by replacing the RFID tag.

An operation 403 establishes a UE connection to the BS by selecting a value M and sending Ek (M, N, BSid, UEid ) and UEtid in message 309 to the MME.

In an operation 405, the MME receives the EK message and maps the UEtid to a permanent id UEid. The MME decrypts the message Ek and verifies that the UEid and UEtid match.

In an operation 407, MME computes Ek (T)=Ekb (M, N, BSid, UEid), and sends Ek (T) to the UE in the message 319.

In an operation 409, UE decrypts Ek to get T and stores T, M, N and BSid for future use.

In an operation 411, the UE receives L broadcasted by BS.

In an operation 413, the UE selects O, and encrypts L, M, N, O and UEid with T and sends session key wR=Et(L, M, N, O, UEid), to BS in message 329.

In an operation 415, BS decrypts the received data and verifies that it matches with L. If N is sufficiently recent, BS starts using session key wR in signaling with UE.

UE and BS continues to communicate in an operation 417 and use session keys wK=Et (L, M, N, O) until the connection is terminated. In a subsequent connection to the MME, the user equipment starts with operation 407. In a subsequent connection to the access point, the UE starts at the operation 411. If the BS desires to be silent before communication, the process starts at the operation 413 using a default L or none at all. When the session is completed, the UE may record some quality metrics about the session and optionally a subjective assessment is made the user. The metrics, in whole or part, may be passed to the MME to enable maintenance of up-to-date information about the quality of the WLAN.

The later attachment to the same WLAN network typically starts with network assistance indicating to the user equipment arrival in the coverage of the WLAN. This indication may be triggered by the cellular network based on mobility functions of the cellular network. Direct end-user input or reading of the same RFID tag may also act as a trigger. The end-user will be requested to affirm that attachment to the WLAN, if desired. Visual and text information obtained from the RFID tag may be used in requesting the confirmation. Additionally, the quality metrics of previous sessions may be displayed to the end-user. The user equipment enters, immediately, a second phase to attach to the LAN. The information obtained in the first time usage of the network is used, but if the information has expired, the first phase is repeated. The end-user may be requested to verify WLAN usage in a similar way upon reading the RFID tag for the first time.

As an alternative procedure for a later attachment, the user equipment may additionally request up-to-date quality metrics of the MME. The information is used to decide about actual attachment requests to the WLAN.

While the invention has been disclosed in terms of a preferred embodiment, various changes can be made without departing from the spirit and scope, as defined in the appended claims, in which:

1. A method comprising:
advertising availability of attachment of a wireless user device (MD) to a wireless local area network, the advertising including machine-readable information attached to a physical object;
scanning the machine-readable information with the MD to receive and store tag information descriptive of the wireless local area network, the tag information including instructions regarding contacting a mobile management entity (MME) in a wide area network (WAN);
sending a signed request message from the MD to the MME allowing the MME to identify the MD and the wireless local area network;
receiving a response message from the MME by the MD wherein the response message provides wireless local area network connection information enabling attachment of the MD to the wireless local area network; and
sending, based on the received response message, an attachment request to the wireless local area network by the MD enabling the wireless local area network to verify that MME and the MD have interacted for purposes of enabling the MD to attach to the wireless local area network.

2. The method of claim 1 further comprising:
evaluating the tag information by the MD for purposes of determining attachment to the wireless local area network.

3. The method of claim 1 further comprising:
establishing a security relationship between the MME and the MD before sending a signed request to the MME.

4. The method of claim 1 further comprising:
authenticating the MD to the MME using an extensible authentication protocol (EAP).

5. The method of claim 1 further comprising:
storing the signed request by the MME for non-repudiation of the MD in subsequent requests for attachment to the wireless local area network.

6. The method of claim 1 further comprising:
including in the wireless local area network connection information at least one of the following: radio configuration, system address (SSID), attachment expiration time and authentication/.authorization data.

7. The method of claim 1 further comprising:
establishing a wireless short-range connection between the MD and the wireless local area network after verification by the wireless local area network that the MD and MME have a valid security association.

8. The method of claim 1 further comprising:
generating secret keys for encryption/decryption of messages establishing a session between the MD and wireless local area network.

9. The method of claim 1 further comprises:
storing the tag information in different media including text, voice and image.

10. The method of claim 1 further comprises:
storing metrics at the MME descriptive of the attachment to the wireless local area network by the MD.

11. A computer program product, executable in a computer system, for managing and controlling access to a wireless local area network comprising:
a computer readable program code for reading a RFID device embedded in a physical object including instructions for attachment of a terminal device to a wireless local area network and down loading the instructions to the terminal;
a computer readable program code for executing the downloaded instructions for generating a request message to a destination in the wide area network for attachment of the terminal device to the wireless local area network; and
a computer readable program code for transmitting the request message to the wide area network and receiving an approval message including a session key to be used for attachment of the terminal device to the wireless local area network.

12. The computer program product of claim 11, further including a computer readable program code for sending a signed request message from the terminal to a mobile management entity (MME) in the wide are network allowing the MME to identify the terminal device and the wireless local area network.

13. The computer program product of claim 12, further including a computer readable program code for sending an attachment request to the wireless local area network allowing the wireless local area network to obtain information from the attachment request enabling the wireless local area network to verify that the MME and terminal have interacted for purposes enabling the terminal to attach to the wireless local area network.

14. A system for managing and controlling access to a wireless local area network comprising:
a physical object at a hotspot location advertising the availability of attachment of a wireless user device (MD) to a wireless local area network, the advertising including machine-readable information attached to the physical object;
a RFID device embedded in the physical object positioned adjacent to the hotspot, storing tag information for attachment of the MD access to the wireless local area network;
a RFID reader in the MD reading the RFID device and down loading the tag information descriptive of the wireless local area network, the tag information including instructions in contacting a mobile management entity (MME) in a wide area network serving as a proxy for the wireless local area network in approving access to the wireless local area network for the MD;
a signed request message from the MD to the MME allowing the MME to identify the MD and the wireless local area network;
an approval message transmitted from the MME to the MD, wherein the approval message provides wireless local area network connection information enabling attachment of the MD to the wireless local area network; and
an attachment request by the MD to the wireless local area network allowing the wireless local area network to obtain information from the attachment request enabling the wireless local area network to verify that the MME and MD have interacted for purposes enabling the MD to attach to the wireless local area network.

15. The system of claim 14 further comprising:
a data section in the tag including voice, text, and image information.

16. The system of claim 14 further comprising:
a processor in the MD configured to evaluate the tag information for determining user interest in attaching to the WLAN.

17. The system of claim 14 further comprising:
a security agreement between the MME and the MD for sending a signed request to the MME.

18. The system of claim 14 further comprising:
a signed request by the MME for non-repudiation of the MD in subsequent requests for attachment to a wireless local area network.

19. The system of claim 14 further comprising:
wireless local area network Connection information including at least one of the following: radio configuration, system address (SSID), attachment expiration time and authentication/.authorization data.

20. The system of claim 14 further comprising:
a signed agreement between the MME and the wireless local area network enabling the MME to serve as a proxy for the wireless local area network authorizing attachment of the MD to the WLAN.

21. The system of claim 14 further comprising:
metrics stored in the MME describing the MD attachments to the wireless local area network.

22. The system of claim 14 further comprising:
secret keys for encryption/decryption of messages in a session between the MD and wireless local area network.

23. A terminal comprising:
a communication unit for providing wireless interface to a local area network and a wide area network, respectively;
a user interface for receiving and transmitting input and output signals related to the attachment of the terminal to a wireless local area network;
a reader module for machine-reading information providing instructions for attachment of the terminal to the wireless local area network from a physical object;
a processor for generating a request message to a destination in the wide area network for attachment of the terminal to the wireless local area network based on the information received via the reader module; and
a transceiver for transmitting the request message to the wide area network and receiving an approval message including a session key to be used for attachment of the terminal to the wireless local area network.

24. The terminal of claim 23 wherein the processor is configured to send a signed request message from the terminal to a mobile management entity (MME) in the wide are network allowing the MME to identify the terminal and the wireless local area network.

25. The terminal of claim 23 wherein the processor is configured to process the received approval message, the approval message providing wireless local area network connection information enabling attachment of the terminal to the wireless local area network.

26. The terminal of claim 25 wherein the processor is configured to send an attachment request to the wireless local area network allowing the wireless local area network to obtain information from the attachment request enabling the wireless local area network to verify that the MME and terminal have interacted for purposes enabling the terminal to attach to the wireless local area network.

27. The terminal of claim 23 wherein the reader module further comprises a control system coupled to a high frequency interface via a transmitter path and a receive path, the control system processing tag data received from a tag via the receive path, according to an application stored in the control system.

28. A method in a terminal device, comprising:
reading a RFID device embedded in a physical object including instructions for attachment of the terminal device to a wireless local area network and down loading the instructions to the terminal device;
executing the downloaded instructions for generating a request message to a destination in a wide area network for attachment of the terminal device to the wireless local area network; and
transmitting the request message to the wide area network and receiving an approval message including a security key information to be used for attachment of the terminal device to the wireless local area network.

29. The method of claim 28, further comprising:
sending an attachment request to the wireless local area network including the security key information.

30. The method of claim 29, further comprising:
gaining attachment to the wireless local area network in response of the attachment request being validated by the wireless local area network.

31. A mobile management entity (MME) in a wide area network for managing and controlling access to a wireless local area network, comprising:
an interface for enabling interaction with a plurality of base station transceivers, wherein the base station transceivers provide radio transmission and reception interface for wireless user devices (MD) within their respective geographic area, the interface being configured to:
receiving a signed request message from an electronic device (MD) for approval of the attachment of the MD to the wireless local area network based on a prior security association established between the MD and the MME; and
sending an approval message including a session key to be used for attachment of the MD to the wireless local area network for authorizing attachment of the MD to the wireless local area network.

32. The MME of claim 31 further comprising:
means for verifying the prior security association between the MME and the MD.

33. The MME of claim 31 further comprising:
means for generating one or more encryption/decryption keys for at least one communication session between the MD and the wireless local area network.

34. The MME of claim 33 wherein the one or more encryption/decryption keys preserve the security of the wireless local area network in a communication session with the MD.

35. The MME of claim 33 wherein the one or more encryption/decryption keys is changed for each communication session between the wireless local area network and the MD.
